(19) United States
(12) Patent Application Publication
(10) Pub. No.: US 2024/0394400 A1
(43) Pub. Date: Nov. 28, 2024

(54) Multi-Party Collaboration System and Method

(71) Applicant: Hubbert Smith, Sandy, UT (US)

(72) Inventor: Hubbert Smith, Sandy, UT (US)

(73) Assignee: Hubbert Smith, Sandy, UT (US)

(21) Appl. No.: 18/323,501

(22) Filed: May 25, 2023

(51) Int. Cl. G06F 21/62

(52) U.S. Cl. CPC G06F 21/6227; G06F 2221/2141

(57) ABSTRACT

This present disclosure includes Multi-Party Collaborators and methods wherein: A given business or public organization establishes a secure digital workspace, a multi-party collaborator. This organization trains the multi-party collaborator using a multi-party AI secrets learner with a training data set of confidential/non-confidential data samples. Once the multiparty collaborator is trained, human users submit AI/LLM queries within the Multi-Party Collaborator. The human submitted query is disaggregated into machine readable tagged, sub-queries, and the AI classifier sorts the dis-aggregated sub-queries into confidential and non-confidential. The Query manager, within the multi-party collaborator, routes the non-confidential sub-query to the large public AI/LLMs, for public processing, routes the confidential sub-query within the Multi-party collaborator for quarantined processing. Taking advantage of large public AI/LLMs where possible and quarantining confidential data where appropriate, and combining the results into a coherent, human-readable result, for additional human interaction and AI Machine iteration.

### CROSS-REFERENCE TO RELATED APPLICATIONS

The present application claims right of priority to granted patent: U.S. Pat. No. 11,669,597 B1 Dated Jun. 6, 2023. titled “Multi-Party Data Science Collaboration System and Method,”. The entirety of which is hereby incorporated by reference. And related U.S. Provisional Application No. 63/069,333, filed Aug. 24, 2020, titled “Multi-Party Data Science Collaboration System and Method,”. The entirety of which is hereby incorporated by reference.

U.S. granted patent U.S. Pat. No. 11,669,597 B1 Dated Jun. 6, 2023, describes a Multiparty Collaborator entity which prevents data leakage of specified data, outside the Multiparty Collaborator. However, this system described in U.S. Pat. No. 11,669,597 does not address the issue of preventing data leakage of specified data, while interacting with large scale public Artificial Intelligence and Large Language Models (AI/LLMs), such as, but not limited to ChatGPT/GPT4.

Also, this system U.S. Pat. No. 11,669,597 does not address the issue of separating confidential from non-confidential sub-queries, then tagging, then routing them appropriately and then re-aggregating both confidential and non-confidential sub-queries to yield a consolidated human-readable response.
To first, take advantage of large scale public Artificial Intelligence and Large Language Models (AI/LLMs). And second, keep confidential sub-queries, confidential and there by prevent confidential data breach. This present disclosure improves on prior art, for these and other capabilities.

### FIELD OF DISCLOSURE

This present disclosure relates generally to systems and methods of collaboration.

In particular, this present disclosure expands and improves upon prior art: Multi-party Collaborator, while benefiting from public large-scale AI/LLM systems, and while protecting against confidential data breaches into public domains or unauthorized private domains.

Collaborating and using large public AI/LLMs may be desirable under many circumstances. For example, to debug computer code, to better specify intellectual property or to analyze business operations data. Queries of this nature benefit from the capabilities of very large AI/LLM.

All queries to public AI/LLMs are stored for learning and other benign reasons. Data stored on public AI/LLMs includes queries from business organizations including confidential information, such as, but not limited to, computer source code, intellectual property, trade secrets, customer data, contracts, creative materials such as literature, music, art, video content and similar.
Once that confidential data is exposed to public systems, control of confidential data is forfeit, data provenance and chain of custody are erased.

This present disclosure relates generally to systems and methods for processing Human User supplied queries and sub-queries, to categorize, manage and execute confidential queries and sub-queries within multi-party collaborator. And subsequently manage and execute queries and sub-queries of non-confidential data on large public AI/LLM systems;

while preventing confidential data breach.

### SUMMARY

This present disclosure allows use of public AI/LLMs by Business, Private/Personal Information, Intellectual Property and/or STEM users without confidential data breach. By analyzing and tagging the many thousands of machine-readable sub-queries, tokens and tensors processed by neural networks or similar, resulting from a human-user query into confidential queries for affordable proprietary AI/LLM, and non-confidential queries to be processed by very large, very expensive public AI/LLM systems.

In this present disclosure, confidential data stays confidential. Confidential data never leaves Multi-Party Collaborator. But users still benefit from non-confidential query processing by larger and more capable public AI/LLM.

This present disclosure improves upon Multi-party collaborator as defined by prior art. Said Multi-party Collaborator, is conceived for use by human users from multiple organizations, for the purpose of project collaboration, where one or many parties contribute confidential information required for collaboration; but confidential data breach is prevented by Multi-party collaborator. This present disclosure improves upon prior-art. Specifically, in a project involving collaboration of multiple parties, any and all credentialed participants of one or more organizations, are prevented from inadvertently or unknowingly causing a confidential data breach of through a query presented to public AI/LLM such as ChatGPT. While all credentialed project users of all organizations can additionally safely make use of public AI/LLM systems (such as ChatGPT) without confidential data breach of either party's data. Systems and methods to define what is confidential data, and what is not confidential data, from multiple-parties is defined herein. Systems and methods for quarantine and processing confidential multi-party data is defined herein.

This present disclosure relates to methods and systems to disassemble one Human User query into many sub-queries, tokens, tensors. And then identify and tag said sub-queries, tokens and tensors, as either confidential or non-confidential based on business or organization training criteria, and handle those confidential queries on confidential infrastructure, or handle non-confidential queries on public AI/LLM infrastructure such as Chat GPT/GPT4, and subsequently re-aggregate those public/private neural net results into a single coherent human-readable response; without breaching confidential data.

This disclosure applies AI supervised training on user-organization-supplied tagged data samples of both confidential and non-confidential information. Each organization supplies tagged data samples which are processed by an AI secrets learner within the multi-party collaborator. The AI secrets learner produces learning model retained for ongoing use within the Multi-party Collaborator, where learning model or training data may not be copied out. The Prior art multiparty collaborator denies unauthorized outbound copy of data.

For this present disclosure, organization-specific AI training produces a working learning model used for identifying said-organizations unique confidential information. This learning model will be subsequently used in statistical analysis of sub-queries generated as described above. Statistical analysis derived from the learning model will determine the likelihood that a given sub-query does, or does not, contain confidential information. Once this learning model is operational, the system is ready for use by human users interacting with a chat-bot similar to interacting with chat-bot interfaces to public systems.

This present disclosure improves on prior art with an improved Multi-Party Collaborator where Human users submit AI/LLM queries which may, or may not, include confidential data. Based upon aforementioned AI trained learning model, this present disclosure analyses queries and sub-queries. Determines if a given sub-query does or does not include confidential information, and keeps confidential data within the Multi-party collaborator; while still allowing processing of non-confidential data on public AI/LLM systems, at the sub-query, token, tensor granularity.

This present disclosure manages and executes confidential sub-queries within Multi-party collaborator; and prevent confidential sub-queries from exposure to public domain systems. Thereby avoiding confidential data breach; but still allowing the advantages of public AI/LLM on non-confidential sub-query workloads.

This present disclosure employs sub-query tagging. The sub-queries tagged non-confidential, exit the Multi-Party Collaborator via API exchange with very large, expensive/unaffordable, very capable, public AI/LLMs involving trillions of data samples, many thousands of servers/gpus, many petabytes; non-confidential processing is conducted on these public AI/LLM systems.

The sub-queries tagged confidential are retained inside the Multi-Party Collaborator. The confidential data is processed on smaller and more affordable AI/LLM infrastructure within the Multi-Party Collaborator. Private, more affordable AI/LLM infrastructure may use tens or hundreds of servers/GPUs and Terabytes of data.

The sub-queries tagged non-confidential managed by the query manager for processing outside Multi-Party Collaborator, by very capable, very expensive, very public AI/LLM such as, but not limited to, ChatGPT, using many thousands of servers/GPUs and many petabytes of data, trained on trillions of data samples.

This present disclosure applies tagging to enable essential AI/LLM operations and data flows such as repeated passes through a neural network with back-propagation involving both confidential and non-confidential sub-queries, tokens, tensors, processing through neural networks to arrive at a statistically optimal answer. Thereafter this present disclosure methods will ingest and re-combine resulting non-confidential data results, with the confidential results, within the Multi-Party Collaborator to then present the Human user with a coherent response.

Improving over prior art: the techniques introduced herein overcome the deficiencies and limitations of the prior art, at least in part, by providing methods to interact with public AI/LLMs such as, but not limited to, ChatGPT/GPT-3 without confidential data breach.

Additional improvements over prior art: these public systems described by prior art, have no methods to keep confidential data confidential.
Simply put, this present invention improves on prior art; such that confidential data stays quarantined inside in private Multi-Party Collaborators; and non-confidential data is so-tagged and may be efficiently and affordably processed by public AI/LLM. This present disclosure enables business users to make use of large public AI/LLMs, without risking confidential data breach.

### BRIEF DESCRIPTION OF DRAWINGS

The disclosure is illustrated by way of example, and not by way of limitation in the figures of the accompanying drawings in which like reference numerals are used to refer to similar elements. Many of these figures include neural net shaped icons. These icons serve to identify the modules and methods employing AI or Machine Learning techniques to perform the designated function.

FIG. 1 is a block diagram of Multi-Party Collaborator, an example system for a Multi-party collaborator for AI with both confidential and non-confidential data in accordance with some implementations. This figure depicts Multi-Party Collaborator and related systems, methods and components which prevent confidential data exfiltration.

FIG. 2 is a flowchart of an example method to of initial creation a learning model based on tagged organization confidential and non-confidential supervised learning processing by machine learning system. The result is trained model for the task of analysis and statistical categorization of sub-queries, by example, “confidential”, “non-confidential”, in accordance with some implementations. This occurs entirely within the Multi-party collaborator workspace in the interest of preventing escape of confidential data.

FIG. 3 is a flowchart of an example method to apply the aforementioned trained learning model process every-day queries wherein confidential or non-confidential information is classified based on the trained learning model. The trained learning model will identify and subsequently tag confidential and non-confidential data. The tagged sub-queries are subsequently sorted and then routed for either non-confidential public LLM processing, or confidential private LLM processing in accordance with some implementations.

FIG. 4 is a flowchart of an example method to subsequently process and then re-aggregate non-confidential and confidential subqueries. While keeping confidential data quarantined within multi-party collaborator and therefore avoiding publicly breached confidential data while still allowing affordable processing of non-confidential/public data in public LLMs, and in accordance with some implementations.

FIG. 5 is an example method for the workflow which clarifies the handling of sub-queries and tokens during the backpropagation and re-aggregation of queries resulting in a human readable query response, in accordance with some implementations.

FIG. 6 is an example method for cleanup of non-confidential query data from public AI/LLM in accordance with some implementations.

### DETAILED DESCRIPTION

The techniques introduced herein, illustrated in FIG. 2, allows businesses and organizations a method to train the system to properly categorize queries and sub-queries involving topics and information deemed confidential, trade secrets, personal information, business information, Intellectual Property, creative content or similar. For example: some source code is very confidential, some source code public. Also, some business data is confidential, other business information is public. The AI Secrets Learner 320 performs supervised learning against a user-supplied tagged data set 400 involving both confidential and non-confidential data. The output of AI Secrets Learner is a neural network inference consumed by Learning Model 410 resulting in a machine learning neural network or similar. Once trained on the organizational data 400, this machine learning neural net will be used to categorize and tag sub-queries during every-day use. Furthermore, this method identifies non-confidential information for processing by expensive public AI/LLMs. This method additionally includes ongoing training of Learning Model 410. Ongoing AI model training, in this present disclosure, involves both user queries and tightly targeted topic-specific publicly available non-confidential information. This training occurs entirely within Multi-Party Collaborator 100, with ongoing data sampling and model evolution; while copying this confidential information to other destinations is prevented.

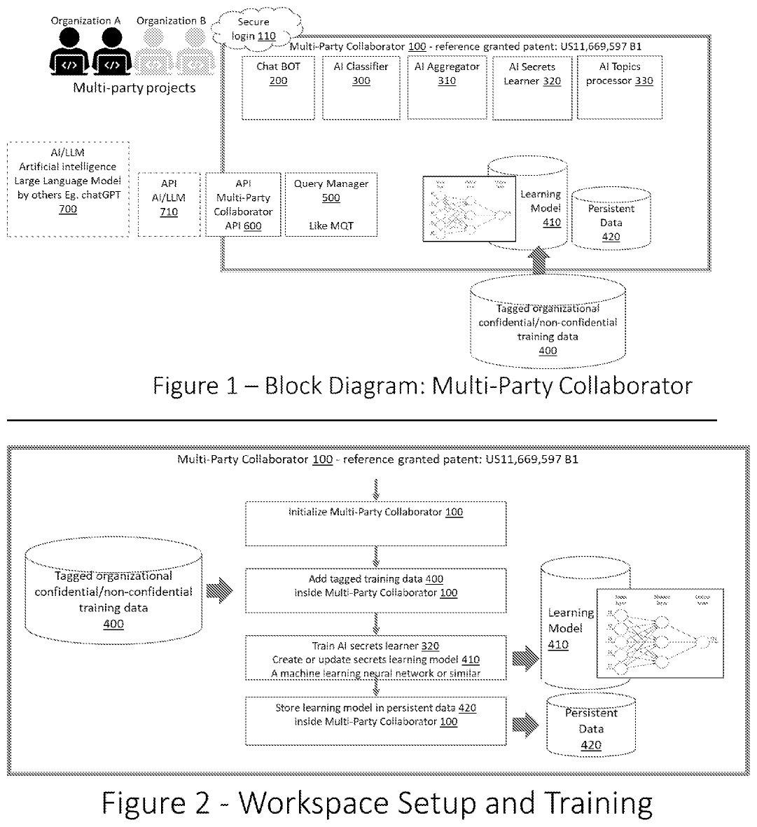

This present disclosure includes a Multi-Party Collaborator 100, illustrated in FIG. 1, consisting of one or more processors, one or more digital networks and one or more digital storage systems, which prevents data breach or exfiltration of confidential information related to natural language interactions with AI systems (this represents an improvement of USPTO patent U.S. Pat. No. 11,669,597 B1). This Multi-party collaborator 100, is conceived for use by human users from multiple organizations, for the purpose of technical project collaboration, where one or many parties contribute confidential information required for collaboration; but confidential data breach is prevented by the Multi-party collaborator 100. Specifically, in a project involving technical collaboration of multiple parties, any and all credentialed participants are prevented from inadvertently or unknowingly cause a confidential data breach through a query presented to public AI/LLM such as ChatGPT. While all credentialed project users, of all organizations, can safely make use of public AI/LLM systems (such as ChatGPT) without confidential data breach of either party's data. Systems and methods to define what is confidential data, and what is not confidential data, from multiple-parties is defined herein. Systems and methods for quarantine and processing confidential multi-party data is defined herein.

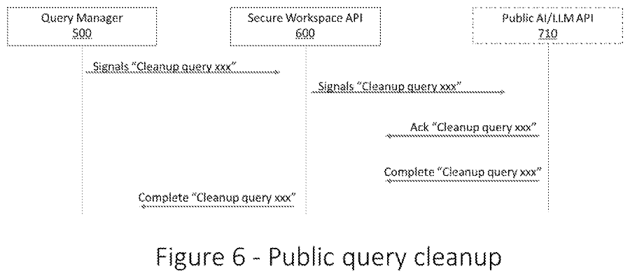

Chatbot 200, illustrated in FIGS. 1, 3, 5 and 6, captures human user queries and passes queries to be performed by AI Topics Processor 330. AI Topics Processor 330 then disaggregates a single human query into many machine-readable sub-queries.

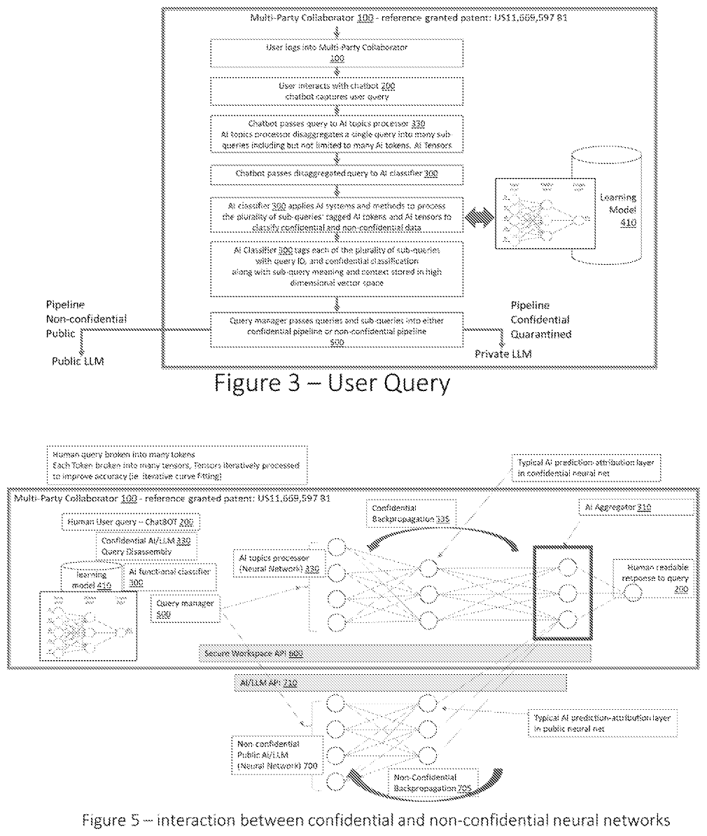

Resulting sub-queries are processed by AI classifier 300 as illustrated in FIG. 3. The AI classifier 300 consumes the machine-readable sub-queries and interacting with the learning model 410 classifies each sub-query as confidential or not confidential.

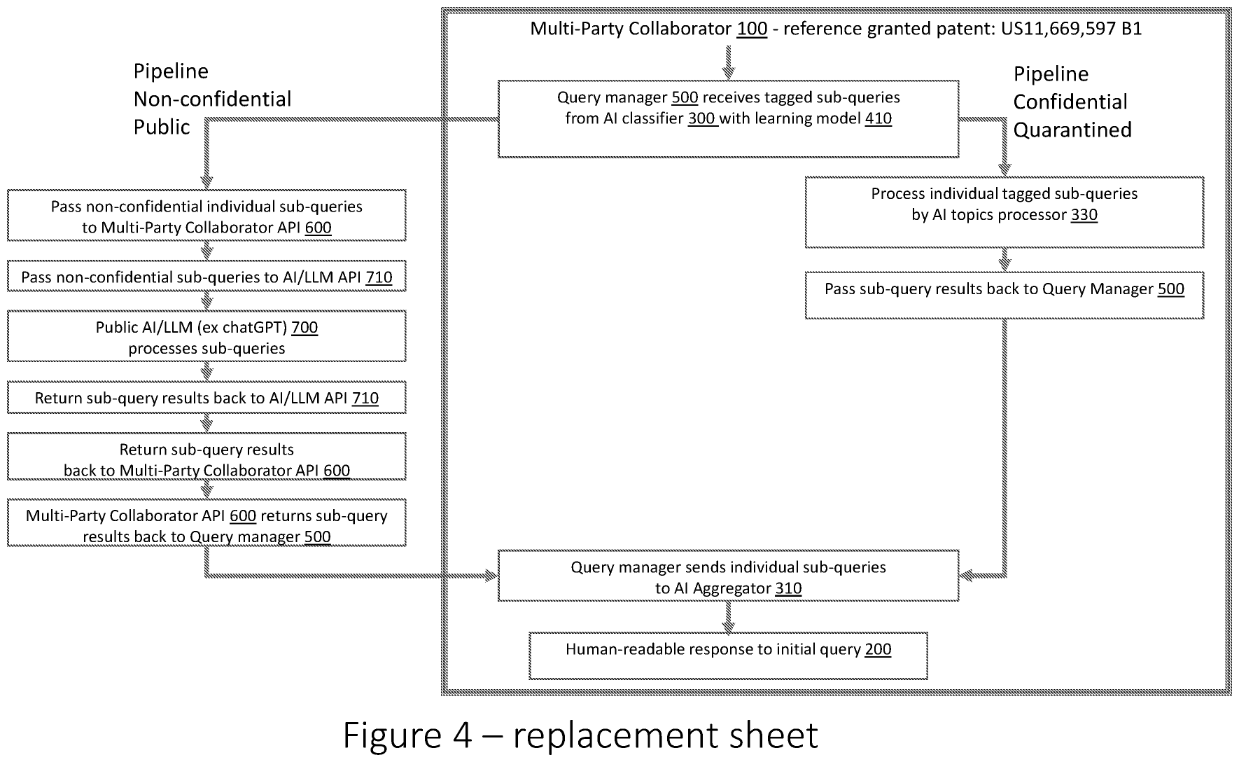

More specifically, AI Topics Processor 330 within Multi-party collaborator workspace, disassembles single Human user queries, each into many subqueries, AI tokens and AI tensors; as illustrated in FIGS. 3, 4 and 5.

Sub-queries, AI tokens, and AI tensors are each categorized and tagged by AI Classifier 300 as either confidential or non-confidential. This tagging is an improvement over existing prior-art using tagging to organize typical AI/LLM queries within neural networks. Tagging by AI Classifier 300 depends on Learning Model 410 trained by secrets learning 320 on organization-specific tagged data 410. This entire process occurs within Multi-Party Collaborator 100.

This present disclosure is an improvement on prior art where confidential data is prevented from leaving the Multi-Party Collaborator 100 by methods of ownership/whitelist logic defined in patent U.S. Pat. No. 11,669,597 B1. Once confidential data is identified and tagged by functional classifier 300, this disclosure employs the user-whitelist approach to deny copy of the confidential data to destinations outside the Multi-Party Collaborator 100.

This present disclosure is an improvement on prior art. Non-confidential data is allowed to leave the secure digital container 100 by methods of ownership/whitelist logic defined in patent: U.S. Pat. No. 11,669,597 B1.

### Routing Confidential and non-Confidential Sub-Queries

For sub-queries tagged “confidential”, Query Manager 500 routes sub-queries to AI Topics Processor 330, running on confidential infrastructure, controlled by the Multi-party collaborator.
For sub-queries tagged “non-confidential”, Query Manager 500 routes sub-queries to Public AI/LLM 700 neural networks outside of Multi-Party Collaborator 100. This includes assigning data tagged non-confidential to the egress whitelist defined in prior art Ser. No. 17/409,460. By adding the tagged data to the whitelist, that non-confidential data is allowed egress, while other confidential data is prevented egress from Multi-Party Collaborator 100.

Once confidential queries, processed by AI topics processor 330, and non-confidential queries processed by public AI/LLM 700 are concluded, they are routed by Query Manager 500, to AI aggregator 310 and are re-aggregated (typical in today's AI and LLM) into a coherent response for presentation to Human User via chatbot 200,

The systems and method of the present disclosure has a number advantages over prior art system and methods.

First, this present disclosure may advantageously provide protection and quarantine of confidential data within Multi-Party Collaborator 100. This present disclosure is an improvement over prior art. For example, Existing solution for public AI/LLMs allow a human user to submit a query which may, or may not, include confidential data. Existing AI/LLMs provide no mechanism whereby human user or organization can control or protect said confidential data.

Once confidential data enters the public AI/LLM, control of confidentiality and chain of custody is forfeit.

Second, this present disclosure may advantageously provide an AI model and learning capability 300 to determine organization-specific confidential data, disaggregate the query/tokens/tensors, and conduct internal AI/LLM processing and maintain quarantine. This improves upon existing solutions which train to identify and tag confidential/non-confidential data; but these existing solutions do not provide the secure data quarantine.

Third, this present disclosure may advantageously provide an AI model and learning capability 300 to identify non-confidential data, disaggregate the query/tokens/tensors, and allow external public AI/LLMs to process non-confidential tasks. This improves upon existing solutions as, this gives organizations the ability to use large public AI/LLM to significant benefit, without risking confidential data. Other existing solutions with proprietary AI/LLMs may also interact with large public AI/LLMs, but will lack the secure data workspace to quarantine confidential data. Large Public AI/LLMs are trained on trillions of data samples, run on many thousands of servers and GPUs, they are unaffordable by typical companies or organizations. This disclosure allows businesses to use large public AI/LLMs without loss of control of said confidential data. Simply put, the confidential data remains quarantined, and the non-confidential data can be processed by public AI/LLMs.

Fourth, this present disclosure may improve over existing solutions as this disclosure disassembles query/token/tensors into confidential/quarantined and non-confidential/public, these are tagged quarantined or public. The confidential/quarantined tokens/tensors are sent to local quarantined AI/LLM processing by Query Manager 500. The non-confidential/public tokens/tensors are sent to public AI/LLM for processing by those very large, very capable models and large infrastructure. Processing includes typical back propagation for iterative results attainment in very large models. Processing includes integration of results by AI Aggregator 310. AI Aggregator 310 combines and performs final AI processing of confidential results with public results within the Multi-Party Collaborator 100 to present the human user a coherent answer.

Fifth, this present disclosure improves over existing solutions as it employs neural network processing which is segmented into public processing 700 and quarantined processing 330, these results are tagged and aggregated via typical AI/ML computer science techniques. The Functional Aggregator 310 integrates the confidential query results and the non-confidential query results, within a Multi-Party Collaborator 100 which disallows data egress (as defined by Ser. No. 17/409,460). The functional aggregator 310 additionally handle reprocessing and back propagation.

### OTHER CONSIDERATIONS

The concepts of “confidential” and “non-confidential” are example classifications used throughout this disclosure, are provided for purposes of explanation and should be understood as example implementations. Related implementations may involve different classification label wording, and/or more than two classifications.

It should be understood that the above-described examples are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces.

However, the present disclosure applies to any type of computing device that can receive data and commands, and to any peripheral devices providing services.

Reference in the specification to “one implementation” or “an implementation” or “some implementations” means that a particular feature, structure, or characteristic described in connection with the implementation is included in at least one implementation. The appearances of the phrase “in some implementations” in various places in the specification are not necessarily all referring to the same implementations.

In some instances, various implementations may be presented herein in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic optical disks, read-only memories (ROMs), random access memories (RAMs), EPROMS, EEPROMs, magnetic or optical cards, or any type of media suitable for storing electronic instructions, each coupled to a computer system bus.

The disclosure can take the form of an entirely hardware implementation, an entirely software implementation or an implementation containing both hardware and software elements. In a preferred implementation, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a flash memory, a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. for determining climate risk using artificial intelligence. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is described with reference to a particular programming language. It will be appreciated that a variety of programming languages may be used to implement the teachings of the disclosure as described herein.

What is claimed is:

1. The creation of, using one or more processors, a plurality of data objects pertaining to one or more training data sets, within a secure digital workspace, for the purpose of creating a machine-readable model trained to identify confidential data within queries and sub-queries, and trained to identify non-confidential data within queries and subqueries.

2. The computer implemented method of claim 1, to use Multi-Party Collaborator to quarantine all data, until specifically tagged non-confidential. To tag non-confidential, methods include ongoing model training employing supervised, semi-supervised and unsupervised learning of organization-specific information and public information targeted to organization-specific topics, for the subsequent purpose of accurate tagging and routing of confidential vs non-confidential queries and sub-queries; for one or plural organizations within a singular project.

3. The computer implemented method of claim 1, to maintain quarantine, disallowing confidential data breach, of all data until specifically tagged non-confidential. Denying access or copy of queries and sub-queries involving confidential information, of one organization or plural organizations, beyond the boundaries of Multi-Party Collaborator; unless explicitly allowed access by a secure whitelist of allowed exfiltration.

4. The processing of, using one or more processors, natural language user queries involving both confidential data and non-confidential data. The processing of singular human query disassembly into plural sub-queries, such as but not limited to, AI tokens and/or AI tensors. The classification and tagging of said disassembled plurality of sub-queries AI tokens or AI tensors includes originating queryID tag, and classification tag. The management and routing entities tagged with query ID for reassembly, and tagged for classification to determine quarantine and routing. Along with query id and classification, each sub-query, AI token or AI tensor will retain meaning and context using vectors in high dimensional geometry as indicated on FIG. 5. This plurality of AI tokens and AI tensor queries and subqueries, remain within the boundaries of the multi-party collaborator until specifically tagged non-confidential and routed to, and processed by, public AI/LLM systems.

5. The computer implemented method of claim 4, to process queries and subqueries which have been tagged non-confidential based on aforementioned training classification model in claim 1, to be routed beyond the boundaries of the multi-party collaborator to public domain Artificial Intelligence systems, including but not limited to systems of large language models, systems of neural networks and systems of machine learning. non-confidential tagged data to be interpreted by AI/LLM, Data Science and Machine Learning systems.

6. The computer implemented method of claim 4, to process queries and subqueries which have been tagged confidential based on aforementioned training classification model in claim 1, to be quarantined and routed only within the boundaries of the multi-party collaborator to, including but not limited to, proprietary or private large language models, systems of neural networks and systems of machine learning. Maintaining secure quarantine of confidential data. unless explicitly allowed access by a secure whitelist of allowed exfiltration.

7. The computer implemented method of claim 4, application programmer interface based methods to remove query remnants from public AI/LLMs.

8. Methods to reassemble both confidential and non-confidential results and present a single coherent response to the human user, while maintaining quarantine of confidential data, and derivatives of confidential data, within the secure multi-party collaborator.
